(19) United States
(12) Patent Application Publication
(10) Pub. No.: US 2026/0109157 A1
(43) Pub. Date: Apr. 23, 2026

(54) NON-IMPACT PRINTING MACHINE COMPRISING CENTRAL CYLINDER AND A CHARGING DEVICE

(71) Applicant: KOENIG & BAUER AG, Würzburg (DE)

(72) Inventors: Frank DENNINGER, Hettstadt (DE); Karl-Heinz HILDENBRAND, Retzbach (DE); Marius MALINA, Eußenheim (DE); Andreas WEIPPERT, Rottendorf (DE); Simon STAHL, Wiesenbronn (DE)

(21) Appl. No.: 19/487,640

(22) PCT Filed: Oct. 24, 2024
(86) PCT No.: PCT/EP2024/080074

§ 371 Date: Nov. 25, 2025

(30) Foreign Application Priority Data
Nov. 10, 2023 (DE) 10 2023 131 229.4

(51) Int. Cl. B41J 11/00; B41J 15/04; B41J 15/16; B41J 29/00

(52) U.S. Cl. CPC B41J 11/0015; B41J 15/046; B41J 15/16; B41J 29/00

(57) ABSTRACT

Examples include a printing machine configured as a non-impact printing machine and that includes at least one print head and a roll unwinding device. A transport path is provided for transport of a printing substrate that is assigned to the printing machine. At least one charging electrode is configured as a DC voltage electrode. An area of the transport path provided for the transport of the printing substrate and that is closest to the at least one charging electrode is arranged upstream from a printing nip defined by the print head. The central cylinder is grounded and the print head is grounded. A smallest distance between at least one ejection opening of the print head and the at least one charging electrode is at least 20 mm.

### CROSS-REFERENCES TO RELATED APPLICATIONS

This application is the PCT/EP2024/080074, filed on 24 Oct. 2024, published as WO 2025/098788 A1 on 15 May 2025, and claiming priority to DE 10 2023 131 229.4 filed on 10 Nov. 2023, and all of which are incorporated by reference herein in their entireties.

### TECHNICAL FIELD

Some examples herein relate to a non-impact printing machine comprising a central cylinder and a charging device.

### BACKGROUND

When ink droplets are ejected from print heads, in addition to the relatively large droplets that are deliberately produced, very small droplets are also undesirably produced, which, due to the low mass-to-air resistance ratio thereof, are not transported onto the printing substrate, but instead float around as a fine mist. These mist droplets can settle in various places, for example in the area of the nozzles of the print head, the electronics, or on other components of a printing machine. There, they can cause corresponding disruptions and must therefore be regularly removed to the greatest extent possible. This is associated with effort and/or machine downtime and is sometimes also not readily possible.

An ink jet printer is known from DE 198 10 061 A1, in which ink droplets are electrically charged, some positively and some negatively, by means of an electrode at the print head, so as to then be caused to migrate in an electric field toward the printing substrate or toward the print head, depending on the charge thereof.

An ink jet printer is known from EP 0 473 179 A2, in which a conveyor belt and a printing substrate are each electrically charged by way of a contact electrode, and ink droplets are electrically charged, some positively and some negatively, by additional electrodes in the area of the print heads.

An ink jet printer is known from EP 1 780 016 A1, in which a printing substrate is electrically charged by a contact electrode, and a print head serves as an electrode to electrically charge ink droplets.

An ink jet printer is known from US 2012/0019589 A1, in which electrodes emit ions that travel toward the printing substrate, entraining ink droplets in the process so as to thereby remove them from the ambient air.

A printing machine is known from WO 2022/028751 A1, comprising a central cylinder, ink jet print heads arranged around this central cylinder, and a charging electrode for fixing printing substrate to the central cylinder.

A non-impact printing machine is known from US 2014/0092174 A1, comprising a central cylinder and multiple ink jet printing units arranged around the same, wherein a charging device is arranged downstream from each print head. This charging device is used to detect ink mist and is therefore arranged behind the print head. It can also be used to bind ink mist to the substrate.

A non-impact printing machine is known from US 2006/0055734 A1, comprising a central cylinder and multiple ink jet printing units arranged around the same, wherein a charging device is arranged downstream from each print head. The charging device is intended to generate charge carriers which adhere to ink droplets that have just landed on a substrate, thereby generating an electric field that, in turn, increases the viscosity of the ink to prevent the ink droplets from spreading. In one exemplary embodiment, a charging device is additionally arranged in front of a first print head.

An ink jet printing machine is known from EP 0 832 742 B1, in which charged ink droplets are initially only generated, without already being moved toward a substrate. The droplets are only accelerated toward the substrate by an electric field between the grounded print head and a substrate support surface. For this purpose, an electrical voltage is present between the substrate support surface and the grounded print head. The goal is to avoid ink mist from the outset by using little energy to generate the drops.

An ink jet printing machine comprising a charging device and a discharging device as well as a grounded central cylinder is known from US 2019/0291492 A1.

An ink jet printing machine comprising a grounded print head is known from US 2019/0160834 A1 and US 2010/0289849 A1, respectively.

### SUMMARY

It is an object of some examples herein to provide a non-impact printing machine comprising a central cylinder and a charging device.

The object is achieved in some examples by a non-impact printing machine having at least one print head characterized in that the at least one print head is grounded.

A printing machine designed as a non-impact printing machine comprises at least one print head, a printing substrate source designed as a roll unwinding device, and at least one central cylinder serving as a printing substrate guide element, with which the at least one print head is aligned. The printing machine is assigned a transport path provided for transporting printing substrate. The printing machine comprises at least one charging device, which comprises at least one charging electrode designed as a DC voltage electrode. An area of the transport path provided for the transport of printing substrate which is closest to the at least one charging electrode is arranged upstream from a printing nip defined by the at least one print head, in particular viewed along this transport path. The at least one central cylinder is grounded. The at least one print head is grounded. A smallest distance between at least one ejection opening of the at least one print head and the at least one charging electrode is at least 20 mm, preferably at least 25 mm, more preferably at least 35 mm, still more preferably at least 45 mm, and still more preferably at least 55 mm. This distance prevents undesirable interference with the print head and the ink contained therein or ejected therefrom, even at high voltages applied to the charging electrode. A charging of the droplets before or during the ejection thereof is thus preferably avoided. Instead, preferably only the printing substrate is charged by way of ions that are emitted by the charging electrode, for example positively or preferably negatively charged ions. As soon as droplets of the undesirable ink mist enter the area of influence of the electrostatically charged printing substrate, a charge transfer occurs within the respective droplet by induction. The corresponding droplet is given an electric dipole moment and can thus be attracted by the charge on the printing substrate. Since the respective droplet is electrically neutral overall, the impingement thereof on the printing substrate has no influence on the charge of the same.

In a refinement, the printing machine is preferably characterized in that a smallest distance between the at least one charging electrode of the charging device and a contact surface of the central cylinder, which is in particular provided for a contact with printing substrate, is at least 10 mm. This prevents an electrical breakdown even at high operating voltages.

In an alternative or additional refinement, the printing machine is preferably characterized in that a base body of the central cylinder is made of carbon fiber-reinforced plastic material. In addition to positive mechanical properties, the conductivity of this material ensures that the entire base body is grounded, in particular as soon as contact with ground is established at least at one point.

In an alternative or additional refinement, the printing machine is preferably characterized in that the contact surface of the central cylinder provided for a contact with printing substrate is made of a material that has an electrical conductivity of at least 1,000 S/m, that is, is a conductor. In combination with the ink, which is at least partially conductive and seeps into the printing substrate after having been applied, the charge carriers can thus simply flow off outside the spatial area in which the ink mist is removed from the ambient air. In an alternative refinement, the printing machine is preferably characterized in that the contact surface of the central cylinder provided for a contact with printing substrate is made of a material that has an electrical conductivity of no more than 10 S/m, that is, is a non-conductor. This allows the electrostatic charge state of the printing substrate to be maintained longer if needed.

In an alternative or additional refinement, the printing machine is preferably characterized in that the at least one charging device comprises at least 20 charging electrodes, preferably at least 50, more preferably at least 100, and still more preferably at least 200. These are preferably distributed in a transverse direction. This enables charging that is as uniform as possible across the width of the printing substrate.

In an alternative or additional refinement, the printing machine is preferably characterized in that the at least one charging device is designed to generate a maximum voltage of at least 10 kV, preferably at least 15 kV, more preferably at least 20 kV, still more preferably at least 25 kV, and still more preferably at least 30 kV. Such high voltages allow an especially effective generation of ions and thus an especially effective charging of the printing substrate.

In an alternative or additional refinement, the printing machine is preferably characterized in that a section of the transport path provided for the transport of printing substrate follows an in particular last print head of the printing machine along the transport path provided for the transport of printing substrate, which at a minimum is spaced at least 150 mm, preferably at least 200 mm, more preferably at least 500 mm, and still more preferably at least 1,000 mm apart from each electrode that is provided for the emission of ions. A discharge preferably takes place via the printing substrate moistened during the printing process. This saves costs for the installation and operation of a discharging device.

In an alternative or additional refinement, the printing machine is preferably characterized in that the at least one print head is designed as a print head that is arranged so as to be stationary during the printing operation and/or that a smallest distance between at least one, and preferably each, ejection opening of the at least one print head and a contact surface of the central cylinder is at least 0.1 mm. This allows high printing speeds and a high print quality to be achieved even with wide printing substrates.

In an alternative or additional refinement, the printing machine is preferably characterized in that the printing machine is designed as an ink jet printing machine and/or that the at least one print head is designed as an ink jet print head. The solvent contained in the ink, for example a conductive solvent, can accelerate the discharge if desired. This ink preferably contains water as a component.

In an alternative or additional refinement, the printing machine is preferably characterized in that an area of the transport path provided for the transport of printing substrate which is closest to the at least one charging electrode is an area in which a contact is provided between the printing substrate and the central cylinder. This ensures that the printing substrate is in an especially well-defined position when it is being charged.

### BRIEF DESCRIPTION OF THE DRAWINGS

Exemplary embodiments of the invention are illustrated in the drawings and will be described in greater detail hereafter. The figures show:

FIG. 1 a schematic representation of a printing machine designed as a web-fed printing machine, comprising multiple print heads and a charging device; and

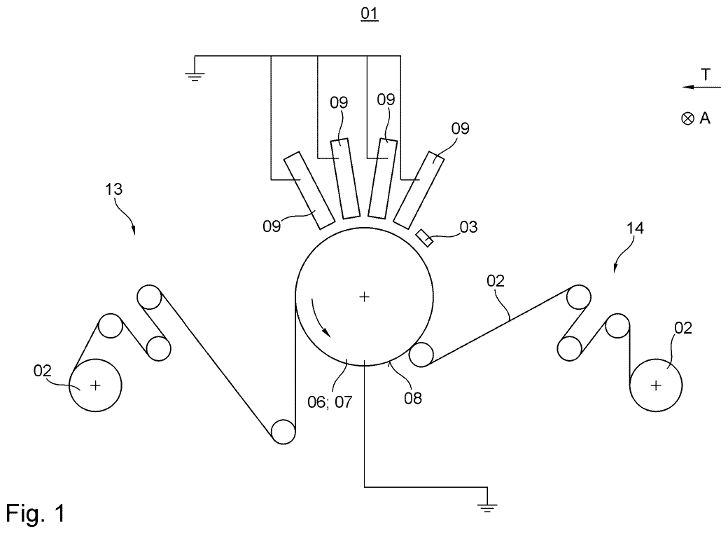

FIG. 2 a schematic enlarged representation of an area around a printing nip of the printing machine.

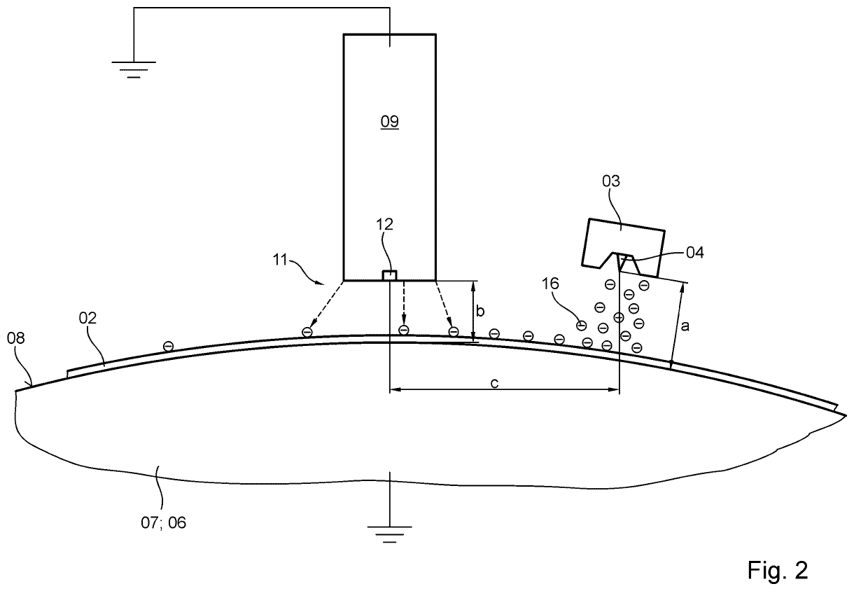

### DETAILED DESCRIPTION

A printing machine 01 is designed as a non-impact printing machine 01 and preferably as an ink jet printing machine 01. The printing machine 01 is used in particular to print onto printing substrate 02. The printing machine 01 is preferably designed as a web-fed printing machine 01. The printing machine 01 is preferably used to print onto web-format printing substrate 02.

A transport path provided for a transport of printing substrate 02 is preferably assigned to the printing machine 01. The transport path provided for the transport of printing substrate 02 is in particular the spatial area that the printing substrate 02, if present, regularly takes up and/or would take up, optionally at least temporarily. In the case of a curved transport path, a transport direction T is preferably in each case the direction T that runs tangential to a segment and/or point of the intended transport path closest to a respective reference point and that is provided for the transport of the printing substrate 02 at this segment and/or point. This particular reference point is preferably situated at the point and/or at the component that is being related to the transport direction T. The transport direction T thus preferably in each case extends along the transport path provided for printing substrate 02. A transverse direction A is preferably a direction A that extends orthogonal with respect to the transport direction T and horizontally. A working width of the printing machine 01 is preferably a dimension that preferably extends in the transverse direction A. The working width of the printing machine 01 preferably corresponds to a maximum width that a printing substrate 02 is permitted to have for the printing machine 01 to still be able to print on it, that is, in particular a maximum web width or optionally sheet width and/or width of the printing substrate 02 that the printing machine 01 is able to process. The width of a printing substrate 02 shall, in particular, be understood to mean the dimension thereof in the transverse direction A. The working width of the printing machine 01 is, for example, at least 50 cm, preferably at least 100 cm, more preferably at least 150 cm, still more preferably at least 200 cm, and still more preferably at least 250 cm.

The printing machine 01 comprises at least one printing substrate source 14. The at least one printing substrate source 14 is preferably designed as a roll unwinding device 14, in particular for web-format printing substrate 02, more preferably as a reel changer 14. The reel changer 14 is preferably designed as a reel changer 14 for a flying reel change.

The printing machine 01 comprises at least one circulatingly movable support element 07, which comprises a circulatingly movable contact surface 08 provided for a contact with a printing substrate 02. The at least one support element 07 is preferably designed as a cylinder 07, in particular as a central cylinder 07. The central cylinder 07 thus serves as a printing substrate guide element 07. The printing machine 01 comprises at least one print head 09, which is in particular designed as an ink jet print head 09. The at least one print head 09 preferably has at least one ejection opening 12, which is in particular used to eject ink droplets in a targeted manner. The at least one print head 09 is preferably designed as a print head 09 that is arranged so as to be stationary during the printing operation. The at least one print head 09 is preferably designed as a print head 09 operating according to the drop-on-demand principle. The at least one print head 09 is preferably arranged so as to be aligned with the at least one support element 07, and in particular with the at least one central cylinder 07. Preferably, the at least one ejection opening 12 of the at least one print head 09 is arranged so as to be aligned with the at least one support element 07, and in particular with the contact surface 08 of this at least one support element 07. The at least one support element 07 is used in particular to hold the printing substrate 02 in a defined position during the printing operation while the ink is being applied thereto. The contact surface 08 is preferably a contact surface 08 that can be moved relative to the at least one print head 09. The contact surface 08 is preferably a contact surface 08 that is circulatingly movable together with the printing substrate 02.

The printing machine 01 comprises at least one charging device 03, in particular for electrostatically charging printing substrate 02. The respective at least one charging device 03 is used in particular to generate ions 16 which are transported to the printing substrate 02 and electrostatically charge the printing substrate 02 by way of their contact or their adhesion. These ions are preferably negatively charged. The printing substrate 02 thus charged is then able to attract and bind fine ink mist, which is undesirably generated during the printing process, to the printing substrate 02.

The at least one charging device 03 comprises at least one charging electrode 04, which is preferably arranged so as to be aligned with the contact surface 08. The at least one central cylinder 07 is preferably grounded. The at least one print head 09 is preferably grounded. For example, a grounded component serves as a counter-electrode 06, in particular at least one component of the central cylinder 07.

For example, a base body of the central cylinder 07 is made of carbon fiber-reinforced plastic material (carbon). The base body is preferably the largest assembly of the central cylinder 07 in terms of volume. In a first specific embodiment of the contact surface 08 of the central cylinder 07 provided for a contact with printing substrate 02, this contact surface 08 of the central cylinder 07 provided for a contact with printing substrate 02 is made of a material that has an electrical conductivity of at least 1,000 S/m (one thousand Siemens per meter), that is, in particular, made of a conductor. This contact surface 08 of the central cylinder 07 is formed, for example, by a metal coating which more preferably contains chromium and/or consists of chromium. In an alternative second specific embodiment of the contact surface 08 of the central cylinder 07 provided for a contact with printing substrate 02, this contact surface 08 of the central cylinder 07 provided for a contact with printing substrate 02 is made of a material that has an electrical conductivity of no more than 10 S/m (ten Siemens per meter), that is, in particular, made of a non-conductor or insulator.

The transport path provided for the transport of printing substrate 02 preferably extends between the at least one circulating contact surface 08 and the at least one charging electrode 04 of the at least one charging device 03. The contact surface 08 is preferably at least partially arranged between the at least one charging electrode 04 and the at least one counter-electrode 06 of the at least one charging device 03.

The at least one charging device 03 is designed in such a way that at least one side of the printing substrate 02, and more preferably the entire printing substrate 02, can be electrostatically charged without contact with the charging device 03. In this way, the corresponding surface of the printing substrate 02 can be treated gently. Preferably, a smallest distance a between the at least one charging electrode 04 of the at least one charging device 03 and the contact surface 08 is greater than a smallest distance b between at least one, and preferably each, ejection opening 12 of the at least one print head 09 and the contact surface 08.

The smallest distance a between the at least one, and in particular each, charging electrode 04 of the at least one charging device 03 and the contact surface 08 is preferably at least 10 mm, more preferably at least 20 mm, still more preferably at least 35 mm, still more preferably at least 50 mm, still more preferably at least 60 mm, still more preferably at least 65 mm, and still more preferably at least 70 mm. The smallest distance a between the at least one, and in particular each, charging electrode 04 of the at least one charging device 03 and the contact surface 08 is preferably no more than 150 mm, more preferably no more than 110 mm, still more preferably no more than 85 mm, and still more preferably no more than 70 mm.

A smallest distance c between at least one, and more preferably each, ejection opening 12 of the at least one print head 09 and the at least one charging electrode 04 is preferably at least 20 mm, more preferably at least 25 mm, still more preferably at least 35 mm, still more preferably at least 45 mm, and still more preferably at least 55 mm.

In an alternative or additional refinement, the printing machine 01 is preferably characterized in that the at least one charging device 03 is designed as a DC charging device 03. This means in particular that a sign of the voltage that is present at the particular charging electrode 04 preferably does not change during operation. The at least one charging electrode 04 is preferably designed as a DC voltage electrode 04. The at least one charging device 03 is preferably designed to generate a maximum voltage, which is at least 10 kV, more preferably at least 15 kV, still more preferably at least 20 kV, still more preferably at least 25 kV, and still more preferably at least 30 kV, and independently thereof, preferably no more than 45 kV, and more preferably no more than 40 kV, and still more preferably no more than 35 kV. In particular, in at least one operating state of the printing machine 01, an electrical voltage of at least 10 kV, more preferably at least 15 kV, still more preferably at least 20 kV, still more preferably at least 25 kV, and still more preferably at least 30 kV, and independently thereof, preferably no more than 45 kV, and still more preferably no more than 40 kV, and still more preferably no more than 35 kV is present between the at least one charging electrode 04 and a grounded object, for example the central cylinder 07 serving as the counter-electrode 06.

The at least one charging electrode 04 is preferably designed as a needle 04. Each such needle 04 has a tip. For each such tip, there are at least two cutting planes which are orthogonal with respect to one another and in which the cutting surface of the tip has a radius of curvature that is less than 0.5 mm, more preferably less than 0.2 mm, and still more preferably less than 0.1 mm. The at least one charging device 03 preferably comprises at least 20 charging electrodes 04, more preferably at least 50 charging electrodes 04, still more preferably at least 100 charging electrodes 04, and still more preferably at least 200 charging electrodes 04. For example, these charging electrodes 04 are arranged next to one another in the transverse direction A. This allows the printing material 02 to be charged especially evenly.

The at least one print head 09 is and, if present, preferably also further print heads 09 are arranged in particular so as to be radially aligned with the cylinder 07 or central cylinder 07, in particular in terms of the respective ejection direction thereof. The at least one charging device 03 comprises the at least one charging electrode 04, which, viewed in the radial direction, is preferably arranged outside the cylinder 07 or central cylinder 07. For example, the central cylinder 07 serves as the counter-electrode 06 of the at least one charging device 03.

Preferably, the at least one charging device 03 is arranged first along the transport path provided for the transport of printing substrate 02, and the at least one print head 09 is arranged thereafter. An area of the transport path provided for the transport of printing substrate 02 which is closest to the at least one charging electrode 04 is preferably arranged upstream from a printing nip 11 defined by the at least one print head 09. A printing nip 11 is in particular the area in which droplets ejected by the at least one print head 09 can regularly impinge on the printing substrate 02 upon appropriate activation of the at least one print head 09. The smallest distance b between at least one, and preferably each, ejection opening 12 of the at least one print head 09 and the contact surface 08, in particular in a working position of the at least one print head 09, is preferably at least 0.1 mm, more preferably at least 0.2 mm, still more preferably at least 0.5 mm, and still more preferably at least 0.9 mm, and, independently thereof, preferably no more than 5 mm, more preferably no more than 2 mm, still more preferably no more than 1.5 mm, and still more preferably no more than 1.1 mm. The working position is in particular the position in which the respective print head 09 is regularly arranged during regular printing operation. An area of the transport path provided for the transport the printing substrate 02 which is closest to the at least one charging electrode 04 is preferably an area in which a contact is provided between the printing substrate 02 and the central cylinder 07.

Preferably, a section of this transport path, which is spaced a minimum distance of at least 150 mm, more preferably at least 200 mm, still more preferably at least 500 mm, and still more preferably at least 1,000 mm apart from each electrode that is provided for the emission of ions 16, adjoins a last print head 09 of the printing machine 01 along the transport path provided for the transport of printing substrate 02.

For example, with appropriate geometric conditions, at least one additional charging device can be arranged downstream from a first print head 09 of the printing machine 01, in particular along the transport path provided for the transport of printing substrate 02, and upstream from a last print head 09 of the printing machine 01, in particular along the transport path provided for the transport of printing substrate 02, so as to counteract excessively rapid discharge of the printing substrate.

The printing machine 01 preferably comprises a printing substrate output device 13, which is designed, for example, as a winding device 13 and/or a cutting device 13 and/or a folding device 13. Web-format printing substrate 02 can, for example, be transported by means of diverting, actively or passively driven rollers and/or cylinders and/or fixed guide elements and/or conveyor belts and/or suction systems.

Although the disclosure herein has been described in language specific to examples of structural features and/or methodological acts, it is to be understood that the subject matter defined in the appended claims is not necessarily limited to the specific features or acts described in the examples. Rather, the specific features and acts are disclosed merely as example forms of implementing the claims.

1-12. (canceled)

13. A printing machine (01) configured as a non-impact printing machine (01), the printing machine (01) comprising at least one print head (09); and the printing machine (01) comprising a printing substrate source (14) configured as a roll unwinding device (14); and a transport path that is provided for a transport of printing substrate (02) being assigned to the printing machine (01); and the printing machine (01) comprising at least one central cylinder (07) serving as a printing substrate guide element (07), with which the at least one print head (09) is aligned; and the printing machine (01) comprising at least one charging device (03), which comprises at least one charging electrode (04) configured as a DC voltage electrode (04); and an area of the transport path provided for the transport of printing substrate (02) which is closest to the at least one charging electrode (04) being arranged upstream from a printing nip (11) defined by the at least one print head (09); and the at least one central cylinder (07) being grounded; and a smallest distance (c) between at least one ejection opening (12) of the at least one print head (09) and the at least one charging electrode (04) being at least 20 mm, characterized in that the at least one print head (09) is grounded.

14. The printing machine according to claim 13, characterized in that a smallest distance (a) between the at least one charging electrode (04) of the charging device (03) and a contact surface (08) of the central cylinder (07) is at least 10 mm.

15. The printing machine according to claim 13, characterized in that the at least one charging device (03) comprises at least 20 charging electrodes (04).

16. The printing machine according to claim 13, characterized in that the at least one charging device (03) is designed to generate a maximum voltage of at least 10 kV.

17. The printing machine according to claim 13, characterized in that an area of the transport path provided for the transport the printing substrate (02) which is closest to the at least one charging electrode (04) is an area in which a contact is provided between the printing substrate (02) and the central cylinder (07).

18. The printing machine according to claim 13, characterized in that a section of the transport path provided for the transport of printing substrate (02), which is spaced a minimum distance of at least 150 mm apart from each electrode that is provided for the emission of ions, follows a last print head (09) of the printing machine (01).

19. The printing machine according to claim 13, characterized in that the at least one print head (09) is configured as a print head (09) that is arranged so as to be stationary during the printing operation.

20. The printing machine according to claim 13, characterized in that a smallest distance (b) between at least one ejection opening (12) of the at least one print head (09) and a contact surface (08) of the central cylinder (07) is at least 0.1 mm.

21. The printing machine according to claim 13, characterized in that the printing machine (01) is configured as an ink jet printing machine (01) and/or that the at least one print head (09) is configured as an ink jet print head (09).

22. The printing machine according to claim 13, characterized in that a base body of the central cylinder (07) is made of carbon fiber-reinforced plastic material.

23. The printing machine according to claim 13, characterized in that a contact surface (08) of the central cylinder (07) which is provided for a contact with printing substrate (02) is made of a material that has an electrical conductivity of at least 1,000 S/m (one thousand Siemens per meter).

24. The printing machine according to claim 13, characterized in that a contact surface (08) of the central cylinder (07) which is provided for a contact with printing substrate (02) is made of a material that has an electrical conductivity of no more than 10 S/m (ten Siemens per meter).
